(19) United States
(12) Patent Application Publication
(10) Pub. No.: US 2022/0393448 A1
(43) Pub. Date: Dec. 8, 2022

(54) CABLE GUIDES

(71) Applicant: Hewlett-Packard Development Company, L.P., Spring, TX (US)

(72) Inventor: Tien Liang Chung, Taipei City (TW)

(21) Appl. No.: 17/337,787

(22) Filed: Jun. 3, 2021

(51) Int. Cl. H02G 3/04

(52) U.S. Cl. CPC H02G 3/0456

(57) ABSTRACT

In some examples, a cable guide can include a translator including a protrusion with an opening and a retention mechanism to retain the translator in a housing. The cable guide can include a cable flange including an arm and an attachment annulus. The cable guide can include a coupling mechanism to couple the translator to the cable flange, where the arm is disengaged from the housing when the cable guide is in a disengaged position and the arm is engaged with the housing and the cable flange and the housing are to form a pathway when the cable guide is in an engaged position.

### BACKGROUND

Computing devices can transmit information to and/or from other devices such as peripheral devices. A computing device may connect to a peripheral device via a wired connection. For instance, a wired connection may connect the peripheral device to a port on the computing device.

Ports may include input/output (I/O) ports. Examples of I/O ports include universal serial bus (USB) ports, audio jacks, card readers, power jacks, High-Definition Multimedia Interface (HDMI) ports, register jack (RJ)s, among others. As described above, I/O ports can be used to support various peripheral devices that may be used in conjunction with the computing device, such as data drives, keyboards, mice, displays, and the like.

### BRIEF DESCRIPTION OF THE DRAWINGS

FIG. 1A is a perspective view of an example of a cable guide consistent with the disclosure.

FIG. 1B is a section view of an example of a cable guide consistent with the disclosure.

FIG. 2 is an exploded view of an example of a system including a cable guide and a latch consistent with the disclosure.

FIG. 3A is a view of an example of a system including a cable guide and a latch in a disengaged position consistent with the disclosure.

FIG. 3B is a section view of an example of a system including a cable guide and a latch in a disengaged position consistent with the disclosure.

FIG. 4A is a view of an example of a system including a cable guide and a latch in an engaged position consistent with the disclosure.

FIG. 4B is a section view of an example of a system including a cable guide and a latch in an engaged position consistent with the disclosure.

FIG. 5 is a perspective view of a housing, a latch in a secure position, a locking mechanism, and a cable guide in an engaged position forming a pathway to route cables consistent with the disclosure.

### DETAILED DESCRIPTION

As mentioned, input/output (I/O) ports such as universal serial bus (USB) ports can be used to support various peripheral devices. Examples of peripheral devices include data drives, keyboards, mice, displays, and the like. A peripheral device may include a wired connection to connect the peripheral device to an I/O port.

A computing device may utilize multiple I/O ports. Utilization of multiple I/O ports can result in multiple wired connections, each with an associated cable. As used herein, the term “cable” refers to an insulated electrical conductor. Such cables can, for instance, allow a peripheral device to connect to an I/O port of a computing device and allow the transfer of information (e.g., data) and/or power therebetween.

Multiple wired connections can result in the presence of multiple cables. The presence of multiple cables can result in an unsightly space in and/or area around a computing device. Further, the presence of multiple wired connections can result in tangled and/or disheveled cables, which can result in a poor user experience.

Moreover, without a secure routing of such a cable connected to an I/O port, chances for theft can be increased relative to using secure cable routing. For example, an unauthorized and/or nefarious individual may readily disconnect a peripheral device from an I/O port of a computing device to steal the peripheral device as compared with approaches utilizing secure cable routing.

Further, some approaches may route and/or secure cables utilizing a cable tie. However, utilizing cable ties can be difficult and/or time-consuming. For instance, cable ties can be difficult to release such as when a user wants to move/disconnect a cable and/or altogether remove a peripheral device connected via a cable to an I/O port of a computing device. For example, a cable tie may have to be physically cut off to release the cable tie. As a result, cable ties may not be reusable and/or may utilize a separate/dedicated tool to release the cable tie.

Cable guides according to the disclosure can provide a secure cable routing mechanism including a latch and cable guide to provide an easy to use cable routing apparatus. A portion of a cable guide can be secured in a housing of a computing device and/or display when not in use to provide a pleasing aesthetic. Additionally, the cable guide can form a pathway with the housing when the cable guide is to be used to route a cable. Further, a cable guide can be employed in conjunction with a lock slot to allow for use of a locking mechanism to prevent theft of a peripheral device and/or the cable guide itself. Accordingly, cable guides can provide for a reusable, effective, secure, and easy to use cable routing apparatus as compared with other approaches.

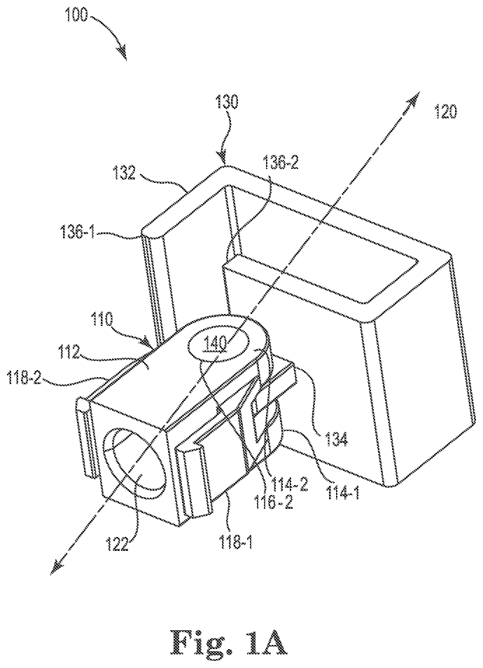

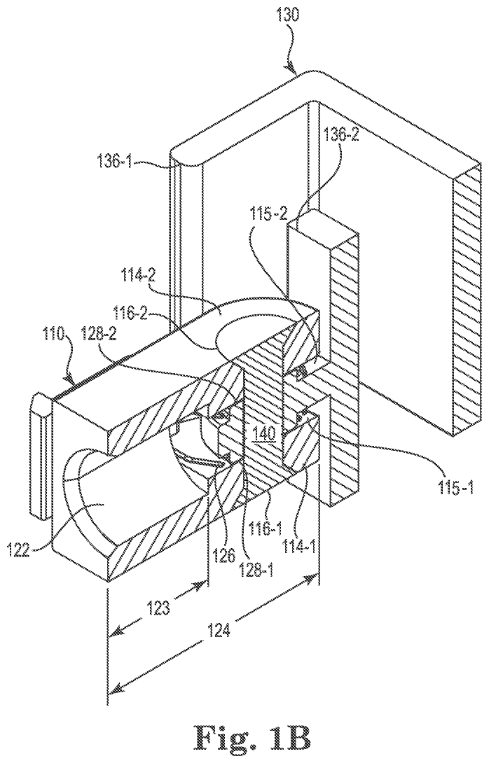

FIG. 1A is a perspective view of an example of a cable guide 100 consistent with the disclosure. FIG. 1B is a section view (as taken along section line 120 in FIG. 1A) of an example of the cable guide 100 consistent with the disclosure. As used herein, the term “cable guide” refers to a device shaped to route a cable. For example, the cable guide 100 can be shaped in a manner to support and/or direct a cable, where the cable guide 100 in combination with a housing can provide a pathway for a cable, as is further described herein.

As illustrated in FIG. 1A, the cable guide 100 can include a translator 110, a cable flange 130, and a coupling mechanism 140. The translator 110 can include a body 112 and a protrusion such as a first protrusion 114-1 and/or a second protrusion 114-2 that extends from the body 112. While illustrated as two distinct protrusions, a quantity, shape, and/or a location of a protrusion can be varied. For instance, an individual protrusion can be employed in some examples.

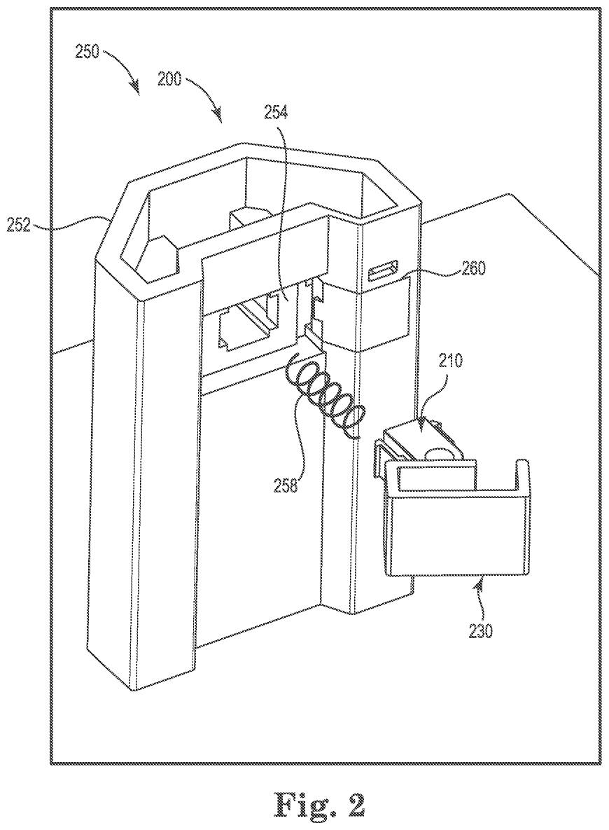

The translator 110 can have a retention mechanism such a first retention mechanism 118-1 and/or a second retention mechanism 118-2 that is to retain the translator 110 in a housing (e.g., housing 252 as illustrated in FIG. 2A). For instance, the retention mechanism can be formed on the body 112 of the translator 110, as illustrated in FIG. 1A. While illustrated as two retention mechanisms, the quantity, shape, and/or location of a retention mechanism can be varied. For instance, an individual retention mechanism can be employed in some examples.

As illustrated in FIG. 1A, a retention mechanism can be a rib or other type of projection extending a distance away from the body 112. However, in some examples, the retention mechanism can be a channel or other type of depression formed in the body 112. For instance, the retention mechanism can be a rib or a channel and the housing can include the other of the rib or the channel. In this way, the rib and the corresponding channel can movably couple the translator 110 to the housing.

The body 112 can define a cavity 122 that is shaped and sized to receive a dispositioning mechanism such as a spring, as detailed herein. The cavity 122 can extend through a portion 123 of a total length 124 of the body 112. For instance, as illustrated in FIG. 1B, the cavity can extend through some but not all of the total length 124 of the body 112. For instance, as illustrated in FIG. 1A and FIG. 1B, the cavity 122 can be cylindrical and can receive a cylindrical dispositioning mechanism (e.g., a cylindrical/helical spring). However, other shapes and/or configurations of the cavity 122 and/or the dispositioning mechanism are possible. As illustrated in FIG. 1A and FIG. 1B, the cavity 122 can be located on an opposite side of the body 112 from the first protrusion 114-1 and the second protrusion 114-2.

The first protrusion 114-1 and the second protrusion 114-2 can be co-located on a side of the translator 110. For instance, as illustrated in FIG. 1A, the first protrusion 114-1 and the second protrusion 114-2 can be co-located on a side of the translator 110 that is on an opposite side of the body from the cavity 122. The first protrusion 114-1 and the second protrusion 114-2 can be the same shape and size, as illustrated in FIG. 1A and FIG. 1B. The first protrusion 114-1 and the second protrusion 114-2 can extend the same distance from the body 112, as illustrated in FIG. 1A and FIG. 1B. Having the first protrusion 114-1 and the second protrusion 114-2 be the same shape, same size, and/or extend the same distance from the body 112 can promote aspects herein such as coupling the translator 110 to the cable flange 130. For instance, the first protrusion 114-1 and the second protrusion 114-2 can together form an area therebetween that is to receive a portion of the cable flange 130 such as an attachment annulus 134 of the cable flange 130.

A protrusion in the translator 110 can include an opening. For instance, the first protrusion 114-1 can include a first opening 116-1 and the second protrusion 114-2 can include a second opening 116-2. The first opening 116-1 and the second opening 116-2 can be the same shape and size. The first opening 116-1 and the second opening 116-2 can be at the same relative location on the first protrusion 114-1 and the second protrusion 114-2, respectively. For instance, having the first opening 116-1 and the second opening 116-2 be the same shape, size, and in the same relative location, as illustrated in FIG. 1A and FIG. 1B, can promote aspects herein such as promoting coupling the translator 110 to the cable flange 130.

The translator 110 can be a continuous extension of material. In other words, the retention mechanism (e.g., the first retention mechanism 118-1 and the second retention mechanism 118-2), the body 112, and the protrusion (e.g., the first protrusion 114-1 and the second protrusion 114-2) can be a unitary body, as illustrated in FIG. 1A and FIG. 1B. Being a unitary body can promote aspects of cable guides herein such as providing structural integrity to translator 110. However, in some examples the retention mechanism, the body, and/or the protrusion can be separate and distinct components which are coupled (e.g., mechanically coupled via a fastening mechanisms such as screw) together. Having the retention mechanism, the body, and/or the protrusion can be separate and distinct components which are coupled together can permit customization of the translator 110 and/or permit replacement of the component over an operational lifetime of the translator 110.

As mentioned above, the cable guide 100 can include a cable flange 130. As used herein, the term “cable flange” refers to an external ridge, rim, and/or projection of material from a cable guide to provide a place for attachment to another object such as a latch. The cable flange 130 can be located, at least partially, external to the housing to define a pathway, as detailed herein.

The cable flange 130 can include an arm 132 and an attachment annulus 134. As used herein, the term “arm” refers to an extension of material to interface with another object. For example, the arm 132 can interface with a surface of a housing to contact the housing and thereby form a pathway for routing cables. For instance, the arm 132 can include a notch to contact a latch and thereby retain the cable flange 130 of the cable guide 100 in the engaged position at which a pathway is formed.

As mentioned, the cable flange 130 can include the attachment annulus 134. As used herein, the term “attachment annulus” refers to a part having an opening to permit the attachment annulus to be coupled, via a coupling mechanism, to another object. For example, the attachment annulus 134 can be utilized to couple the cable flange 130 to a translator 110 as illustrated in FIG. 1A and FIG. 1B. The attachment annulus 134 can be ring-shaped. However, in some examples, the attachment annulus may have a different shape other than ring-shaped (e.g., rectangular, hexagonal, etc.).

In some examples, the cable flange 130 can be a continuous extension of material. In other words, the cable flange 130, the arm 132 and the attachment annulus 134 can be a unitary body, as illustrated in FIG. 1A and FIG. 1B. Having the cable flange 130, the arm 132 and the attachment annulus 134 be a unitary body can promote aspects of cable guides herein such as providing structural integrity to permit the arm 132 to readily engage/disengaged with a housing. However, the arm 132 and/or the attachment annulus 134 can be separate and distinct components which are coupled to the cable flange 130. Having the arm 132 and/or the attachment annulus 134 be separate and distinct components which are coupled to the cable flange 130 can permit customization of the cable flange 130 and/or permit replacement of the component over an operational lifetime of the cable guide 100.

The cable flange 130 can include a first distal end 136-1 and a second distal end 136-2 that are located at opposite respective ends of the cable flange 130. The arm 132 can located at or have a portion of the arm 132 that forms the first distal end 136-1, as illustrated in FIG. 1A and FIG. 1B. The attachment annulus 134 can be located at or have a portion of the attachment annulus 134 which forms the second distal end 136-2, as illustrated in FIG. 1A and FIG. 1B. Having the arm 132 and/or the attachment annulus 134 be located at or form a distal end can promote aspects of cable guides such as permitting the arm 132 to readily engage/disengage with a latch, as detailed herein.

The coupling mechanism 140 can couple the cable flange 130 to the translator 110 and permit the cable guide 100 to move between an engaged position and a disengaged position, as detailed herein. Stated differently, the coupling mechanism 140 can movably couple the cable flange 130 to the translator 110. Examples of suitable coupling mechanisms include pins, hinges, and/or other types of mechanical coupling mechanisms. For instance, the coupling mechanism 140 can be a pin (e.g., a cylindrical pin) that rotatably couples the translator 110 to the cable flange 130.

The cable guide 100 can include a torsion mechanism 126, as illustrated in FIG. 1B. The torsion mechanism 126 can be a torsion spring, among other types of torsion mechanisms. The torsion mechanism 126 can be disposed at an interface (e.g., interface 115-1 and/or interface 115-2, as detailed herein) between the translator 110 and the cable flange 130, as illustrated in FIG. 1B. As such, the torsion mechanism 126 can contact and impart a force on the translator 110 and the cable flange 130 to disposition the translator 110 to a given position (e.g., a disengaged position) relative to the cable flange 130. For example, the torsion mechanism 126 can be disposed at the interface 115-1 between the first protrusion 114-1 and the attachment annulus 134, the second protrusion 114-2 and the attachment annulus 134, or both. For instance, as illustrated in FIG. 1B a portion (e.g., a coil) of the torsion mechanism 126 can be disposed at the interface 115-1 and another portion of the torsion mechanism 126 can be disposed at the interface 115-2, while the respective ends of the torsion mechanism 126 contact and impart forces on respective surfaces of the translator 110 and the cable flange 130 to disposition the cable flange 130 to a disengaged position.

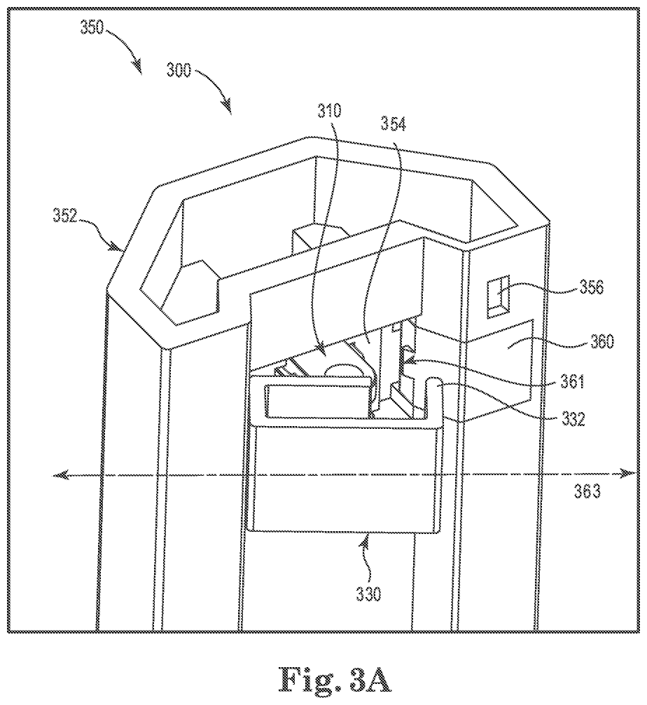

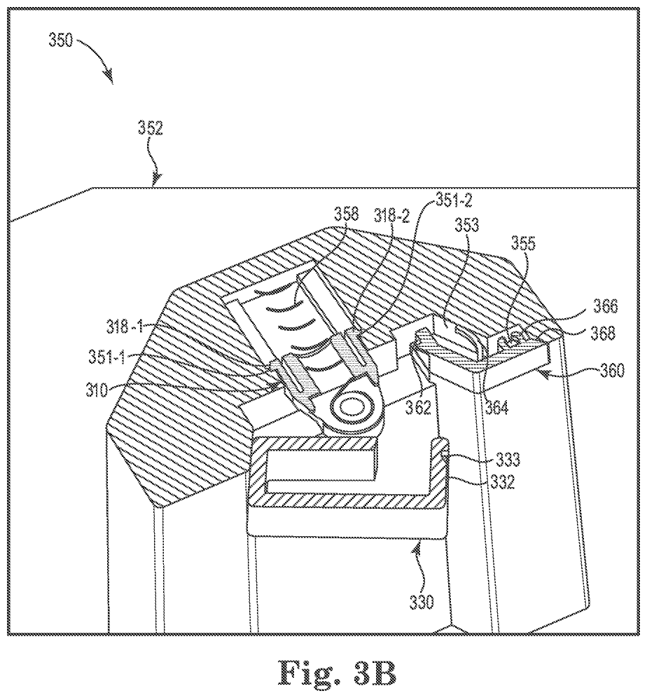

FIG. 2 is an exploded view (exploded view of FIG. 3A) of an example of a system 250 including a cable guide 200 and a latch 260 consistent with the disclosure. The cable guide 200 and the latch 260 can together form a routing mechanism. As used herein, the term “latch” refers to a device to mechanically attach to another device. For example, the latch 260 can mechanically attach to a housing 252 and to the cable guide 200, as is further described herein.

As used herein, the term “housing” refers to an enclosure or other support structure of a device. For example, the housing 252 can be an outer shell making up a portion of a computing device, a display device, and/or an all-in-one (AIO) computing device, etc. As used herein, an AIO computing device refers to a computer which integrates the internal components into the same housing as the display and can offer a touch input functionality of a tablet device while also providing a processing power and a viewing area of desktop computing systems.

The housing 252 can include a recessed surface 254. The recessed surface 254 can be a portion of a structure defining an opening and/or cavity in the housing 252. As used herein, the term “recessed surface” refers to a portion of a structure that is located away from an outer surface of the structure. The recessed surface can be located on an interior portion of the housing 252. The opening formed by the recessed surface 254 in the housing 252 can receive the routing mechanism and its constituent components (the latch 260 and/or the cable guide 200), as is further described herein.

A dispositioning mechanism 258 can be disposed between the housing 252 and the translator 110 to disposition the cable guide 200 away from the housing 252. For example, the dispositioning mechanism 258 can be a spring that is disposed in the opening in the housing 252 and in a corresponding cavity (e.g., cavity 122 as described in FIG. 1) that can be compressed to disposition the cable guide 200 away from the housing. For instance, the spring can include a first distal end that is to contact a surface of the housing and a second distal end that is to contact a surface of the translator. In this way, the cable guide 200 can be dispositioned toward a disengaged position.

The cable guide 200 can be movable between the disengaged position and an engaged position via rotation of the cable flange 230 relative to the translator (e.g., rotation about the attachment annulus), via translation of a translator 210 relative to the housing 252, or both. For instance, the cable guide 200 can be dispositioned toward a disengaged position collectively by a first (translational) force imparted by the dispositioning mechanism 258 and by a second (rotational) force imparted by a torsion mechanism (e.g., torsion mechanism 126 as described in FIG. 1A and FIG. 1B).

FIG. 3A is an view of an example of a system 350 including a cable guide 300 and a latch 360 in a disengaged position consistent with the disclosure. FIG. 3B is a section view (taken along section line 363 in FIG. 3A) of an example of a system 350 including a cable guide 300 and a latch 360 in a disengaged position consistent with the disclosure. As used herein, the term “disengaged position” refers to an orientation of the cable guide 300 in which the cable guide is substantially disposed outside of a housing 352 and no pathway is formed with the housing 352. In the disengaged position, the cable guide 300 does not provide a pathway for routing cables, for example as there may not be any cables to route. For instance, when in the disengaged position, an arm 332 of a cable flange 330 is disengaged with the latch 360, as illustrated in FIG. 3A and FIG. 3B. Thus, when in the disengaged position there is an absence of contact (no contact) between the cable flange 330 and a release tab 362, as detailed herein, of the latch 360.

The translator 310 can be extended substantially out of an opening in the housing 352, as illustrated in FIG. 3A and FIG. 3B. The opening can be defined by the recessed surface 354.

In some examples, a lock slot 356 can be provided. As used herein, the term “lock slot” refers to an opening in a material such as a latch and/or a housing that is to receive a locking mechanism. The lock slot 356 can be included in the latch 360 or can be included in the housing 352 at a location that is proximate to the latch 360.

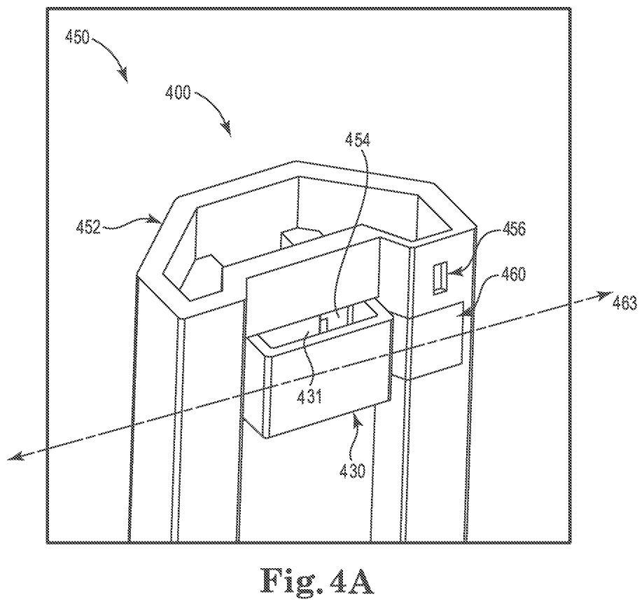

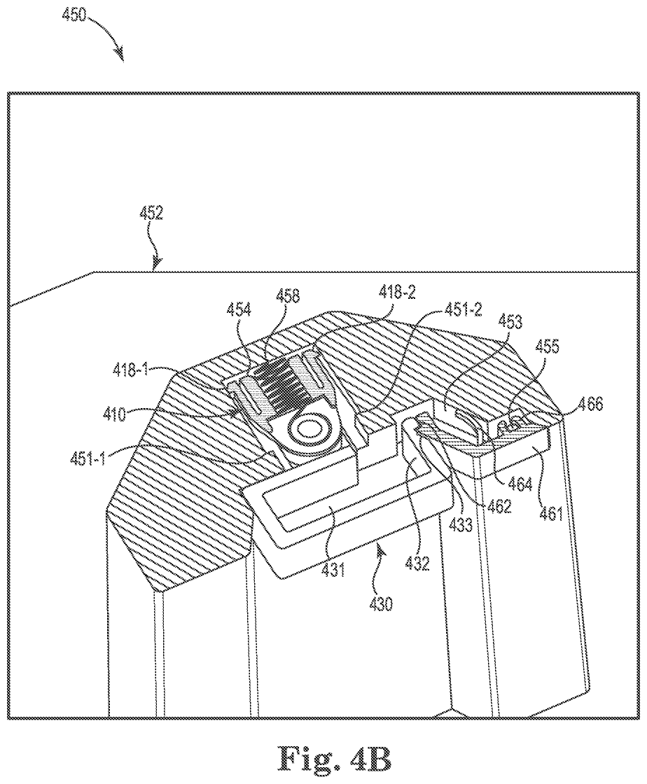

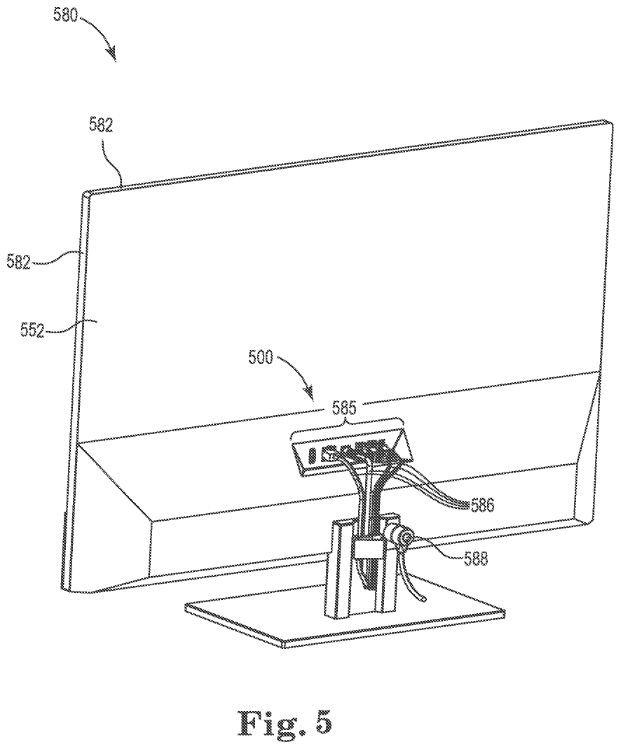

To prevent an unauthorized removal of a cable and/or a peripheral device, the lock slot 356 can receive a locking mechanism (e.g., locking mechanism 588 as illustrated in FIG. 5). As used herein, the term “locking mechanism” refers to a device to secure an object in a particular position. For example, the locking mechanism can directly secure the latch 360 in the secure position by blocking removal of the latch 360. For instance, the locking mechanism can prevent a user from depressing the latch 360, which can prevent movement (e.g., rotation and/or translation) of the cable guide 300 and in turn prevent the size of the pathway (e.g., pathway 431 as illustrated in FIG. 4B) from being modified. For instance, the lock slot 456 can be proximate to the latch such that a locking mechanism, when disposed in the lock slot 456, is to obstruct the latch from moving from a secure position to a release position, as detailed herein. Thus, in some examples, the locking mechanism can be disposed in and removably coupled to the lock slot 456.

When the cable guide 300 is in the disengaged position, the translator 310 can be extended substantially out of an opening in the housing 352 and the cable flange 330 can be rotated away from a latch 360, as illustrated in FIG. 3A. For instance, the translator 310 can be dispositioned to the extended position as illustrated in FIG. 3B due to a force imparted by the disposition mechanism 358.

When the cable guide 300 is in the disengaged position, a retention mechanism such as the first retention mechanism 318-1 and the second retention mechanism 318-2 can retain the translator 310 in the opening of the housing 352. For instance, the first retention mechanism 318-1 can contact a portion 351-1 of a recessed surface 354 and the second retention mechanism can contact another portion 351-2 of the recessed surface 354 when in the disengaged position, as illustrated in FIG. 3B.

A mentioned, when the cable guide 300 is in the disengaged position there can be an absence of contact between the cable flange 330 and the latch 360. For instance, the arm 332 can include a notch that is to contact the latch 360 and thereby retain the cable guide 300 in the engaged position, as detailed herein. However, when in the disengaged position there can be an absence of contact between the notch 333 and the latch 360. For instance, as illustrated in FIG. 3A and FIG. 3B, the latch 360 can include a release tab 362, a spring tab 364, and a coupling mechanism 366 to engage with the housing 352. When in the disengaged position there can be an absence of contact between the release tab 362 and the notch 333.

The latch 360 can be a continuous extension of material. For instance, the release tab 362, the spring tab 364, and the coupling mechanism 366 can be a unitary body, as illustrated in FIG. 3B. Having the release tab 362, the spring tab 364, and the coupling mechanism 366 can be a unitary body can promote aspects of cable guides such as permitting the latch 360 to be coupled to the housing 352 and yet be sufficiently pliable to permit coupling/decoupling with the cable flange 330.

A distal end 368 of the latch 360 can be a planar angled surface, as illustrated in FIG. 4A and FIG. 4B. Having the distal end 368 be a planar angled surface can ensure the coupling mechanism 346 remains coupled to the protrusion 555 of the housing when a force is applied to the latch. For instance, a force can be applied to the latch 360 to cause a portion of the latch 360 (e.g., the release tab 362) to deform a distance away from the arm 332 of the cable flange 330 when in the engaged position and thereby permit the notch 333 to be released from the release tab 362. For instance, responsive to a force applied to the latch 360 the spring tab 364 can deform permit the release tab 362 to move a distance away from the notch 333 to permit the notch to be released from the release tab 362.

As illustrated in FIG. 3B, the latch 360 can further include a spring tab 364. As used herein, the term “spring tab” refers to a projection of material from a body to bias the body to a position. For example, the spring tab 364 can be a projection of material from the latch 360 to bias the latch 360 to a position (e.g., a secure position). When the spring tab 364 experiences a bending moment, the spring tab 364 can bend and the latch 360 moves from a secure position to a release position and when the bending moment is removed, the spring tab 364 can cause the latch 364 to move back to a secure position. In other words, the spring tab 364 may be a resilient component capable of returning to its original or starting position or shape after undergoing a deformation. For instance, the spring tab 364 can be a curved member to promote the spring tab 464 to deform (experience a bending moment) responsive to a force applied to the latch 460.

FIG. 4A is a view of an example of a system 450 including a cable guide 400 and a latch 460 in an engaged position consistent with the disclosure. FIG. 4B is a section view (taken along section line 463 of FIG. 4A) of an example of a system including a cable guide 400 and a latch 460 in an engaged position consistent with the disclosure.

As used herein, the term “engaged position” refers to an orientation of the cable guide in which the cable guide is substantially disposed outside of the housing and a pathway is formed with the housing. In the engaged position, the cable guide 400 can provide a pathway for routing cables, as is further described herein. When the cable guide 400 is in the engaged position there is contact between the cable flange 430 and the latch 460. For instance, an arm 432 can include a notch 433 that is in contact with (interferes with) the latch 460 and thereby retains the cable guide 400 in the engaged position, as detailed herein. As illustrated in FIG. 4B, when the cable guide 400 is in the engaged position, a retention mechanism such as the first retention mechanism 418-1 and the second retention mechanism 418-2 are not in contact with a portion 451-1 and another portion 451-2, respectively, of the recessed surface 454.

As mentioned, the latch 460 can include a release tab 462, a spring tab 464, and a coupling mechanism 466. As used herein, the term “release tab” refers to a projection or portion of a material to receive a force. Such a force can cause a bending moment in the latch 460 to cause the latch 460 to move from a secure position to a release position, as is further described herein. However, when in the engaged position there is contact between the release tab 462 and the notch 433 when the cable flange 430 is proximate to the latch 460, as illustrated in FIG. 4B.

Further, when the cable guide 400 is in the engaged position, the translator 410 can be substantially retained in an opening formed by a recessed surface 454, as illustrated in FIG. 4A and FIG. 4B. Further, when the cable guide 400 is in the engaged position, the cable flange 430 and the housing 452 can form a pathway, as detailed herein with respect to FIG. 5. Thus, the latch 460 and the cable guide 400 can interface together to provide a cable routing mechanism to route cables in and/or around a housing via a cable pathway, as is further described herein. For instance, as illustrated in FIG. 4B, the cable guide 400 can form a pathway 431. For example, the cable flange 430 and an outer surface of the housing 452 can form a pathway 431 to route a cable. As used herein, the term “pathway” refers to an opening formed by objects through which another object can be passed. For instance, a cable of a USB Type-C connector (e.g., or other cables/connectors) can be passed through the pathway 431.

FIG. 5 is a perspective view of a housing, a latch (e.g., latch 460 as illustrated in FIG. 4A) in a secure position, a locking mechanism 588, and a cable guide 500 in an engaged position forming a pathway to route cables 586 consistent with the disclosure. As used herein, the term “secure position” refers to an orientation of the latch in which a release tab of the latch is engaged with a notch of a cable flange. For example, when the latch is in a secure position, the latch 560 prevents any lateral (or substantially lateral) movement of the cable guide 500.

A user may depress the release tab (e.g., release tab 362 as illustrated in FIG. 3A). In response to the force on the release tab, the latch is to move from the secure position to a release position. As used herein, the term “release position” refers to an orientation of the latch in which a release tab of the latch is disengaged from a notch of a cable guide. When the latch is in the release position (e.g., as illustrated in FIG. 3A), the latch can allow lateral (or substantially lateral) movement of the cable guide 500.

As illustrated in FIG. 5, the locking mechanism 588 can be employed. Examples of locking mechanism 588 include a Kensington lock (and the lock slot can be a Kensington Security Slot). However, examples of the disclosure are not so limited. For example, the locking mechanism 588 can be any other type of locking mechanism.

As illustrated in FIG. 5, the electronic device 581 can be a monitor 582 having a housing 552 which forms a stand for the monitor 582. As illustrated in FIG. 5, the cables 586 can be routed through the pathway and connectors 585 corresponding to the cables 586 can be connected to I/O ports of the housing 552. As illustrated in FIG. 5, the connectors 585 and corresponding cables 582 have been routed through the pathway and the cable guide 500 is secured in the engaged position. However, if a user wished to remove or reroute the cables 586 and associated connectors, a user may simply depress the release tab to move the latch from the secure position to the release position and adjust a size of the pathway by moving (e.g., rotating and/or translating) the cable guide 500.

Cable guides according to the disclosure can allow for secure routing of cables in and/or around a housing. Such cable routing can provide for an organized and re-usable cable routing system that can prevent tangled cables and/or reduce clutter in and/or around the housing. Additionally, such a routing mechanism can allow for easier movement and/or removal of cables as compared with previous approaches. Further, the routing mechanism can provide increased security to prevent unauthorized removal of such cables from the housing as compared with previous approaches.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 100 in FIG. 1A and an analogous element may be identified by reference numeral 300 in FIG. 3A. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

1. A cable guide comprising:
a translator including:
a first protrusion with a first opening;
a second protrusion with a second opening; and
a retention mechanism to retain the translator in a housing;
a cable flange including:
an arm to engage with the housing and a release tab of a latch; and
an attachment annulus; and
a coupling mechanism that extends through the first opening, the second opening, and the attachment annulus to couple the translator to the cable flange, wherein:
the arm is disengaged from the release tab when the cable guide is in a disengaged position; and
the arm is engaged with the release tab and the cable flange and the housing are to form a pathway when the cable guide is in an engaged position.

2. The cable guide of claim 1, wherein the coupling mechanism is a pin that is to rotatably couple the translator to the cable flange.

3. The cable guide of claim 1, wherein the cable flange is a unitary body including the arm and the attachment annulus.

4. The cable guide of claim 3, wherein the cable flange includes a first distal end and a second distal end opposite the first distal end, wherein the arm is located at the first distal end.

5. The cable guide of claim 1, wherein the cable flange includes a planar portion disposed between the attachment annulus and the arm.

6. The cable guide of claim 1, wherein the cable guide is movable between the disengaged position and the engaged position via:
rotation about the attachment annulus;
translation of the translator relative to the housing; or
both.

7. The cable guide of claim 1, wherein the arm further comprises a notch to contact the latch and retain the cable guide in the engaged position.

8. An apparatus, comprising:
a latch including a release tab, a spring tab, and a first coupling mechanism to engage with a housing; and
a cable guide comprising:
a translator including:
a first protrusion with a first opening;
a second protrusion with a second opening; and
a retention mechanism to retain the translator in the housing;
a cable flange including:
an arm to engage with the housing and the latch; and
an attachment annulus; and
a second coupling mechanism that extends through the first opening, the second opening, and the attachment annulus to couple the translator to the cable flange, wherein:
the arm is disengaged from the release tab when the cable guide is in a disengaged position; and
the arm is engaged with the release tab and the cable flange and the housing are to form a pathway when the cable guide is in an engaged position.

9. The apparatus of claim 8, wherein the first protrusion and the second protrusion are co-located on a side of the translator.

10. The apparatus of claim 8, further comprising a torsion mechanism disposed at an interface between the first protrusion and the attachment annulus, the second protrusion and the attachment annulus, or both, to disposition the cable flange into the disengaged position.

11. The apparatus of claim 10, further comprising a dispositioning mechanism to disposition the cable guide to the disengaged position.

12. The apparatus of claim 11, wherein the dispositioning mechanism is a spring.

13. A system comprising:
a housing having a recessed surface defining an opening;
a latch including a release tab, a spring tab, and a first coupling mechanism; and
a cable guide comprising:
a translator including:
a first protrusion with a first opening;
a second protrusion with a second opening; and
a retention mechanism to retain the translator in the housing;
a cable flange including:
an arm to engage with the housing; and
an attachment annulus; and
a second coupling mechanism that extends through the first opening, the second opening, and the attachment annulus to couple the translator to the cable flange, wherein:
the arm is disengaged from the release tab when the cable guide is in a disengaged position extended from the recess; and
the arm is engaged with the release tab and the cable flange and the housing are to form a pathway when the cable guide is in an engaged position in the recess.

14. The system of claim 13, wherein the translator further includes a cavity to receive a spring.

15. The system of claim 13, wherein a first distal end of the spring is to contact a surface of the housing and a second distal end of the spring is to contact a surface of the translator to disposition the cable guide to the disengaged position.

16. The system of claim 13, wherein the retention mechanism is a rib or a channel, and wherein the recessed surface of the housing further includes the other of the rib or the channel to movably couple the translator to the housing.

17. The system of claim 13, wherein the translator is a unitary body including the first protrusion, the second protrusion, and the retention mechanism.

18. The system of claim 13, wherein the housing further includes a lock slot.

19. The system of claim 18, wherein the lock slot is located proximate to the latch such that a locking mechanism, when disposed in the lock slot, is to obstruct the latch from moving from a secure position to a release position.

20. The system of claim 18, wherein the locking mechanism is removably coupled to the lock slot.
